(19) United States
(12) Patent Application Publication
(10) Pub. No.: US 2010/0126429 A1
(43) Pub. Date: May 27, 2010

(54) Dog Relaxing Clip

(76) Inventor: Jane Lindemann, Sloatsburg, NY (US)

Correspondence Address: Andrew Berks, 109 Washington St, New York, NY, 10006, US

(21) Appl. No.: 12/623,376

(22) Filed: Nov. 21, 2009

Related U.S. Application Data
(60) Provisional application No. 61/117,107, filed on Nov. 22, 2008.

(51) Int. Cl. A01K 29/00

(52) U.S. Cl. 119/712

(57) ABSTRACT

A clip that grasps loose skin to the nape of the neck of a dog to relax the animal is provided. The clip has two blades pivotally connected, whereby each blade has a jaw section on the ventral side of pivot, a handle section on the dorsal side of the pivot, sufficient cushioning on the lip of each jaw to prevent injury when applied to the animal. An optional embodiment provides a control to lock the blades in position. The clip may be useful in dog grooming or to relax dogs in veterinary medicine.

### FIELD OF THE INVENTION

This invention pertains to the field of dog grooming and methods of restraining dogs during grooming.

### BACKGROUND

Many breeds of dogs require regular grooming which can be difficult in many cases. Many individual animals are not cooperative during grooming, which increases the difficulty and expense of grooming, and risks injury to the animal.

Dog grooming is typically performed on a table with a restraining device including a tether and collar. See, for example, Powers, in U.S. Pat. No. 7,219,625. However, even with a restraining device such as this, a dog has considerable freedom to squirm if uncooperative.

One solution to this problem is to grasp the back of the neck of the dog, which is known to relax the animal. It is well known that adult dogs carry puppies by picking them up by the back of their necks. This grasping of the back of the neck pacifies the puppy as it is carried in its mother's mouth. It is known in art of dog grooming that adult dogs can also be relaxed by being grasped in the back of the neck. Often, in dog grooming, the groomer will engage an assistant to grasp the back of the neck of an uncooperative dog gently but firmly to pacify the animal. It is readily apparent, however, that using an assistant requires two people to groom an animal, i.e., a third hand is necessary.

### SUMMARY OF THE INVENTION

This invention provides a clip for application to the back of the neck of a dog during grooming to relax the animal, with two blades pivotally connected. Each blade has a jaw section on the ventral side of pivot, and a handle section on the dorsal side of the pivot. The lip of each jaw has cushioning so as not to injure the animal when the clip is used. A spring aligned on the axis of the pivot applies tension around the pivot axis, so that there is anywhere from 1 to 20 pounds of tension, as measured at the mouth of the jaws. The jaw section grasps the back of the neck of a dog, applying pressure to pressure points in the animal that causes the animal to relax. Also provided is a method for relaxing

In an embodiment, a control is provided to adjust the amount of tension on the spring.

In an embodiment, a locking device is provided that locks the clip in a closed position.

### BRIEF DESCRIPTION OF THE DRAWINGS

FIG. 1 is a perspective view of the inventive clip.

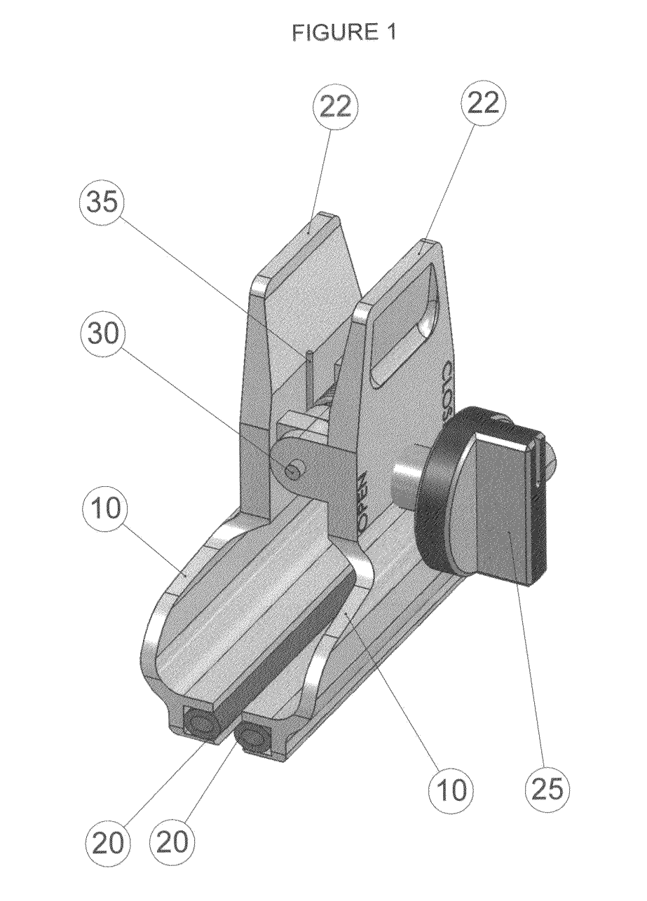

FIG. 2 is an elevation view of the inventive clip.

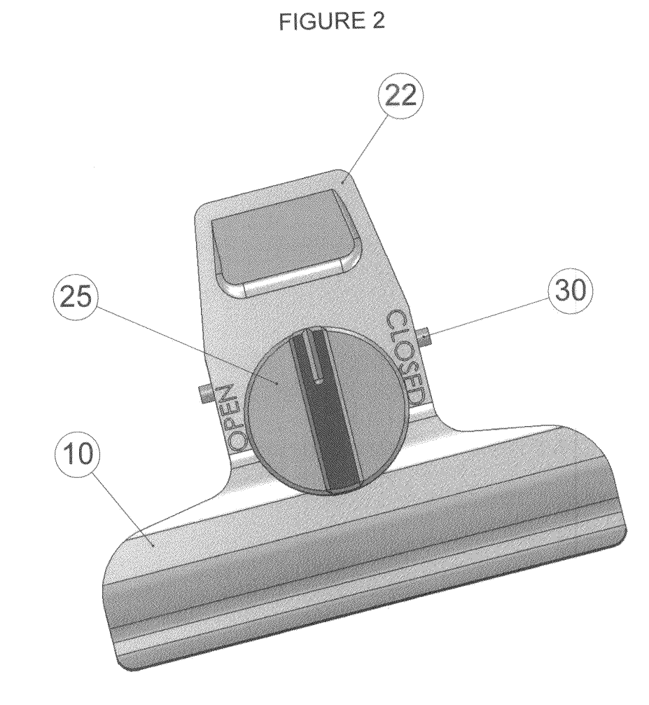

FIG. 3 is a perspective view of the inventive clip along the longitudinal axis.

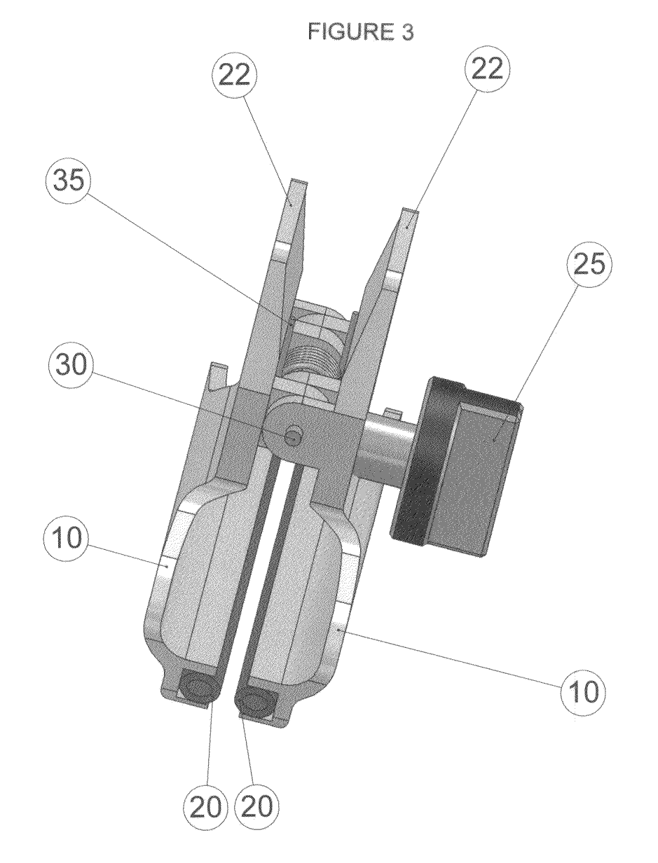

FIG. 5 is an exploded diagram showing the parts of the clip.

FIG. 5 is a schematic of the clip in complete operation on a dog.

### DETAILED DESCRIPTION

The invention comprises a clip with a handle and a jaw section, such that tension in the jaws, when the clip is applied to the nape of the neck of a dog, causes the dog to relax. The clip disclosed herein is designed to grasp loose skin on the back of the neck of a dog, which is a natural pressure point in dogs that usually causes the animal to relax. This is the same reflex action that a mother dog uses to carry pups in her mouth.

In an embodiment, a clip is provided for application to the back of the neck of a dog, with two blades pivotally connected, whereby each blade has a jaw section on the ventral side of pivot, a handle section on the dorsal side of the pivot, sufficient cushioning on the lip of each jaw to prevent injury when applied to the animal, and a spring aligned on the axis of the pivot that provides tension at the mouth of the jaws, so that the jaw section of the clip grasps loose skin on the back of the neck of a dog with sufficient force to cause the animal to relax.

In an embodiment, the clip is further equipped with a locking control, that locks the blades in position around the pivot axis. For example, a knob may be provided with an “open” and “closed” position. In the “open” position, the blades are free to be loosened by the operator grasping and squeezing the handle sections together, or tightened by the action of the spring which forces the blade sections together. In the “closed” position, the blades are locked in place and cannot be tightened or loosened. By locking the blades with the locking control, the clip is not dependent on the tension of the spring to hold it in place.

In an embodiment, a method of relaxing a dog is provided, comprising a clip for application to the back of the neck of a dog, with two blades pivotally connected, whereby each blade has a jaw section on the ventral side of pivot, a handle section on the dorsal side of the pivot, sufficient cushioning on the lip of each jaw to prevent injury when applied to the animal, and a spring aligned on the axis of the pivot that provides tension at the mouth of the jaws, so that the jaw section of the clip grasps loose skin on the back of the neck of a dog with sufficient force to cause the animal to relax.

Referring to the figures, the clip has two blades 10, wherein each blade has a jaw 20, and a handle section 22. A pivotal axle 30 joins the two blades. A spring 35 is positioned around the pivot to naturally force the jaw section of the blades toward each other. The action of pressure on the handle sections forcing them together counters the action of the spring. The jaws comprise lips on the blade with cushioning to prevent injury to the animal. In an embodiment, the cushioning may be a soft and pliant rubber hose affixed to the jaw of the clip. In other embodiments, the cushioning may be a gel strip.

The amount of torque on the clip, measured at the jaws, is between 1 and 20 pounds. A preferred torque is approximately 4 pounds.

In an embodiment, the clip is equipped with a locking control, shown in the figures as a locking knob 25 with an “open” and “closed” position. The locking control has a mechanism (not shown) that locks the blades in position. Thus, in operation, the tension on the spring is used in the initial grasping action on the loose skin in the nape of the dog, but after the clip is positioned properly, by rotating the knob to the “closed,” or locked position, the clip no longer relies on the force of the spring to remain in position grasping the dog's body. Rather, the action of the lock and the inability of the jaws to separate keeps the clip in position.

In operation, a dog groomer grasps the clip at handles 22 and squeezes the handles together, forcing the blades open. The jaws are then placed on the nape of the neck of a dog being groomed, and the groomer releases the handles, so that the jaws firmly, but gently and securely, grasp loose skin on the animals' neck. If equipped with a locking knob, the groomer may lock the lock the clip in position.

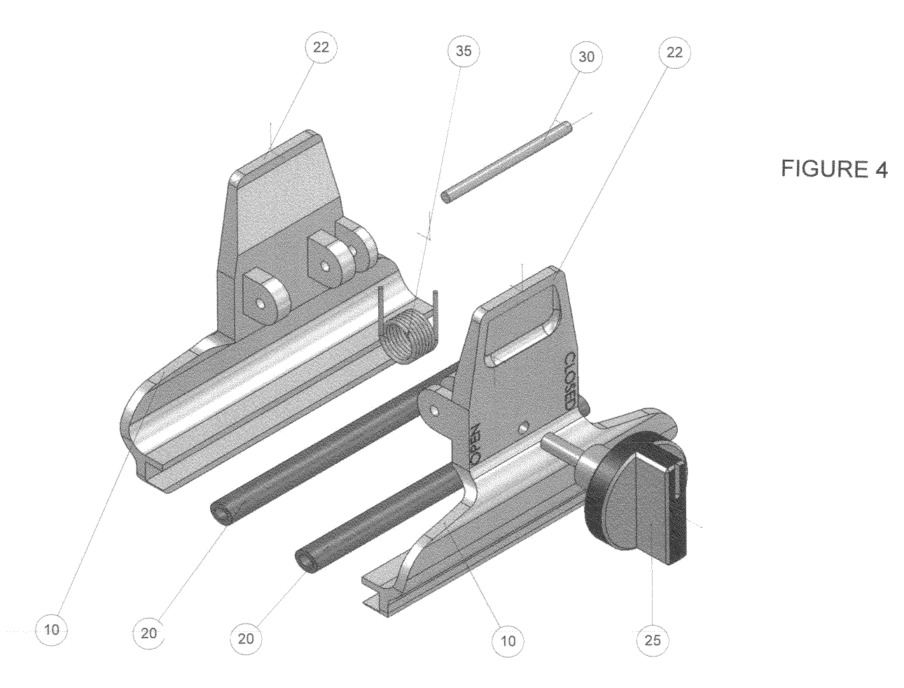

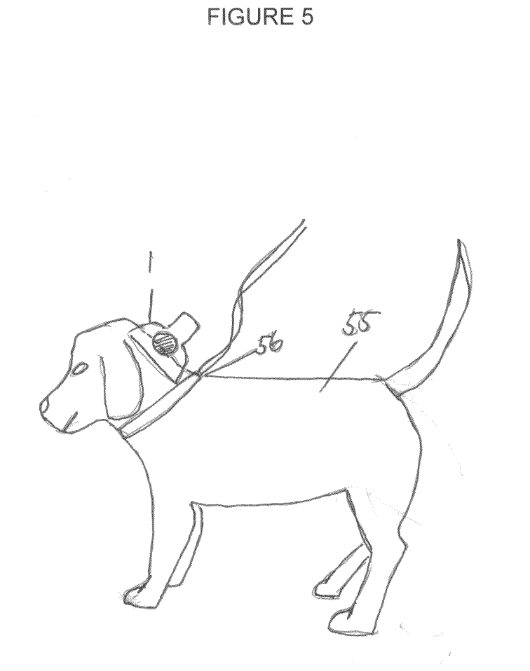

FIG. 5 is a schematic of the clip in use. A dog 55 on a grooming table is depicted, with a dog collar and tether 56 to hold the dog in position. The inventive clip 1 is shown in position on the nape of the neck of the dog.

A plurality of sizes will be necessary to accommodate different size dogs. For example, the clip may be made in extra small, small, medium, large, and extra large sizes. The extra small clip may be approximately 2 inches (5 cm) long. The small size may be approximately 3 inches (7.5 cm) long. The medium size clip may be approximately 4 inches (10 cm) long. The large and extra large sizes may be approximately 5 inches (13 cm) and 6 inches (15 cm), respectively. Other sizes are possible.

In an embodiment, the spring of the inventive clip may have a tension adjustment. For example, there may be a dial provided on one end of the pivot axis that can be turned to change the tension of the spring. In this manner, the most appropriate amount of tension can be applied for the individual animal. For example, differences in thickness of the coat may require a different amount of tension to achieve the desired relaxation effect.

The body of the clip can be manufactured from any suitable material, such as plastic, aluminum, or steel.

The lip of the jaws will require a cushion to protect the skin of the animal, such as a soft foam material or a gel pad, so that the stiff body of the clip is not directly touching the animal.

By the use of this clip, a dog that will not relax during grooming can often be calmed down. With this clip, a single person may be able to relax the dog and groom the animal, which is an advantage over the prior art, where an assistant grasped the back of the neck. Other exemplary uses of this clip might be in veterinary medicine, for use to relax a non-cooperative dog. Additionally, the use of this clip in, for example, grooming or veterinary medicine, may allow the handler to avoid administering a sedative medication to the animal that would otherwise be necessary.

1. A clip for application to the back of the neck of a dog, comprising two blades pivotally connected, whereby each blade has a jaw section on the ventral side of pivot, a handle section on the dorsal side of the pivot, sufficient cushioning on the lip of each jaw to prevent injury when applied to the animal, and a spring aligned on the axis of the pivot that provides tension at the mouth of the jaws, so that the jaw section of the clip grasps loose skin on the back of the neck of a dog with sufficient force to cause the animal to relax.

2. The clip of claim 1, further comprising a control that locks the blades in position around the pivot axis.

3. The clip of claim 1, wherein the amount of tension measured at the mouth of the jaws is between 1 and 20 pounds.

4. The clip of claim 1, further comprising a control to adjust the amount of tension on the spring.

5. A method of relaxing a dog, comprising a clip according to claim 1 applied to the back of the neck of a dog.
